(19) United States
(12) Patent Application Publication
(10) Pub. No.: US 2017/0213250 A1
(43) Pub. Date: Jul. 27, 2017

(54) PLATFORM FOR COMMUNICATING MESSAGES INDICATING CURRENT AVAILABILITY OF SERVICES

(71) Applicants: Esteven Ortega, Salt Lake City, UT (US); Xiaoli Ortega, Salt Lake City, UT (US)

(72) Inventors: Esteven Ortega, Salt Lake City, UT (US); Xiaoli Ortega, Salt Lake City, UT (US)

(21) Appl. No.: 15/325,037

(22) PCT Filed: Jul. 7, 2015
(86) PCT No.: PCT/US15/39431

§ 371 Date: Jan. 9, 2017

Related U.S. Application Data
(60) Provisional application No. 62/022,251, filed on Jul. 9, 2014.

(51) Int. Cl. G06Q 30/02

(52) U.S. Cl. CPC G06Q 30/0257; G06Q 30/0255; G06Q 30/0259; G06Q 30/0261

(57) ABSTRACT

Service providers can communicate messages to nearby customers to indicate the current availability of services. Customers can also communicate messages to nearby service providers that indicate customer requests for services. Service providers that are located along a path traveled by a customer can be identified and displayed to a customer.

### BRIEF SUMMARY

The present invention extends to methods, systems, and computer program products for communicating messages to nearby customers that indicate the current availability of services. The present invention also extends to methods, systems, and computer program products for communicating messages to nearby service providers that indicate customer requests for services. The present invention also extends to method, systems, and computer program products for identifying service providers that are located along a path traveled by a customer.

In one embodiment, the present invention is implemented as a method for sending service notifications to nearby customers. Information is received from a service provider. The information describes a currently available service that the service provider provides. Customer information is then accessed to identify one or more customers that have specified an interest in receiving service notifications from the service provider. A location of each of the one or more customers is determined from the customer information. The location of each of the one or more customers is compared to a location of the service provider. A service notification is then sent to each of the one or more customers whose location is within a specified distance of the service provider. The service notification indicates that the service is currently available at the service provider.

In another embodiment, the present invention is implemented as a method for sending service requests to nearby service providers. Information is received from a customer. The information describes a service that the customer would like performed. Service provider information is accessed to identify one or more service providers that provide the service. A location of each of the one or more service providers is determined from the service provider information. The location of each of the one or more service providers is compared to a location of the customer. A service request is then sent to each of the one or more service providers that has a location that is within a specified distance of the customer. The service request identifies the service that the customer would like performed.

In another embodiment, the present invention is implemented as a method for displaying service providers of interest to a customer that are located along a path of the customer. A path that the customer has or will travel is identified. An indication that the customer is interested in a particular type of service is received from the customer. One or more service providers that provide the particular type of service and that are located within a specified distance of the path are determined. The one or more service providers are then caused to be displayed to the customer.

This summary is provided to introduce a selection of concepts in a simplified form that are further described below in the Detailed Description. This Summary is not intended to identify key features or essential features of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computing environment in which the present invention can be implemented;

FIG. 2 illustrates an example of how service notifications can be sent to selected customers;

FIG. 3 illustrates an example of how service requests can be sent to selected service providers; and

FIG. 4 illustrates an example of how service providers that are located along a customer's path can be displayed.

### DETAILED DESCRIPTION

Embodiments of the present invention may comprise or utilize special purpose or general-purpose computers including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system.

Computer-readable media is categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similarly storage medium which can be used to store desired program code means in the form of computer-executable instructions or data structures and which can be accessed by a general purpose or special purpose computer. Transmission media include signals and carrier waves.

Computer-executable instructions comprise, for example, instructions and data which, when executed by a processor, cause a general purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

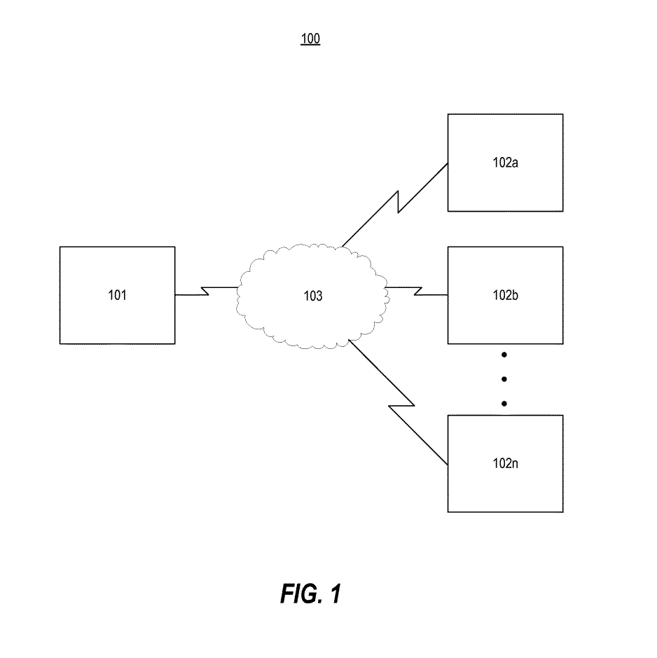

FIG. 1 illustrates an example computer environment 100 in which the present invention can be implemented. Computer environment 100 includes a server system 101, client systems 102a-102n, and a network 103 interconnecting server system 101 with client systems 102a-102n. Server system 101 can represent any number and configuration of server systems, devices, and/or components. For example, server system 101 can be a single server computing device or a cloud of server components. Similarly, client systems 102a-102n can represent the many different types of computing devices and systems that can communicate with server system 101 via network 103. For example, client systems 102a-102n may represent desktop computers, laptop computers, tablets, smart phones, etc. Network 103 can typically be the internet although other network connections, such as local connections, could also be employed. In preferred embodiments, at least one of client systems 102a-102n is a mobile device having location reporting capabilities. For example, one or more of client systems 102a-102n can be a mobile phone with GPS capabilities that is configured to report its location to server system 101.

Client systems 102a-102n generally represent two types of systems or devices: service provider systems and customer devices. A service provider system is any computing system or device employed by a service provider to communicate with server system 101. Accordingly, a service provider system may be a server, a desktop computer, a mobile device, etc. A customer device is also any device that communicates with server system 101. Accordingly, as will be further described below, server system 101 can act as an intermediary for relaying communications between service provider systems and customer devices.

In accordance with embodiments of the present invention, server system 101 can enable a service provider system to broadcast the current availability of a service to customer devices that are within a specified distance of the service provider. Server system 101 can provide an interface through which a service provider system may submit information identifying a currently available service. Then, server system 101 can identify one or more customer devices that should receive a notification that the service is currently available at the service provider (hereinafter referred to as a “service notification”).

A service notification notifies the customer that the customer could immediately receive the service upon visiting the service provider. A service should be construed broadly to encompass any type of service that can be immediately provided upon a customer visiting the service provider. For example, a service should encompass the provision of goods whether or not the provision of goods is the only service provided. As an example, a service notification can be broadcast indicating that a good is immediately available for purchase at a reduced price. A service should also encompass cases where the service will be provided on an ongoing basis. For example, a service notification can be broadcast indicating that a membership can be obtained at a gym or other location that provides services on an ongoing basis. In short, a service notification can indicate that any type of service can be immediately obtained at a nearby location. Immediate in this context implies that the customer would not have a substantial wait if the customer were to promptly visit the service provider to receive the service.

To enable identifying which customer devices should receive a particular service notification, server system 101 can provide an interface through which customers can register to receive service notifications. To register, a customer can specify the type of services for which he or she desires to receive service notifications. For example, a customer may specify a desire to receive service notifications when a haircut service or oil change service is currently available.

The customer may also specify a distance. Server system 101 can use a customer's specified distance to determine whether the customer is within the specified distance from the service provider when the service notification is to be broadcast. For example, if a service provider requests that a service notification be broadcast to customer devices and a customer has specified a distance of one mile, server system 101 can determine whether the customer is within one mile of the service provider, and if so, transmit the service notification to the customer.

The specified distance allows a customer to specify a maximum distance that the customer would be willing to travel to receive a currently available service. Each customer can therefore specify a custom distance that suits his or her desires. In some embodiments, a customer may specify a different distance for different types of services. In this way, the customer can indicate that he or she would be willing to travel farther to receive one service than to receive another.

Accordingly, server system 101 can select which customer devices will receive a service notification for a particular type of currently available service based on whether a customer has specified an interest in the particular type of service and whether the customer is within a specified distance of the service provider. In this way, a service provider can notify nearby potential customers of an immediately available service.

The location of a customer can be determined in any suitable manner. For example, a mobile application executing on the customer device can be configured to determine the device's current location via GPS and then report the current location at regular intervals to server system 101. In other embodiments, server system 101 may be configured to request the location of customer devices in response to receiving a request to broadcast a service notification. This “on-demand” reporting can be employed to minimize the amount of data required to be transmitted by the customer devices. The same mobile application used to report a customer's location may also be used to receive and display service notifications.

By employing server system 101 as an intermediary between the service provider and the customer, the customer's identity (including location and contact information) can remain hidden from the service provider. In other words, the customer's location, contact information, and interests can reside on server system 101 with the service provider only providing sufficient information to identify the service that is currently available. Server system 101 can use the information provided by the service provider to construct the service notification.

In some instances, a service notification may only include information describing the currently available service including where the service can be received. In other instances, a service notification can include information or functionality for responding to the service provider. For example, a service notification can include a link which when selected on the customer device allows the customer to communicate with the service provider such as to make an immediate appointment. This communication can be carried out directly between the customer and the service provider (e.g. by employing a phone, text messaging, or email application), or may be carried out via server system 101 (e.g. by employing the same mobile application used to report the customer's location and to receive the service notification).

In some embodiments, in addition to specifying a type of service that the customer is interested in, a customer may also be able to specify a particular service provider from which the customer does or does not want to receive service notifications. A customer may desire to receive service notifications from a particular service provider regardless of the type of service. In such cases, the customer can specify an interest in receiving any service notification from the service provider without having to specify an interest in all types of services that the service provider offers. Similarly, a customer may not desire to receive any service notifications from a particular service provider. In such cases, the customer can “blacklist” the service provider to prevent receiving any service notifications from the service provider while still being able to receive service notifications for the types of services offered by the blacklisted service provider.

In some embodiments, server system 101 can provide a ratings system. The ratings system can be configured to receive customer reviews and/or ratings of service providers. A rating for each service provider can be generated based on these customer reviews and/or ratings. Then, when a service notification is received, the customer can use the rating of the service provider, which may be included in the service notification or otherwise accessible via a mobile application used to receive the service notification, to determine whether to seek the advertised service. In some embodiments, a mobile application used to receive service notifications can provide an interface for both providing and reviewing ratings of a service provider.

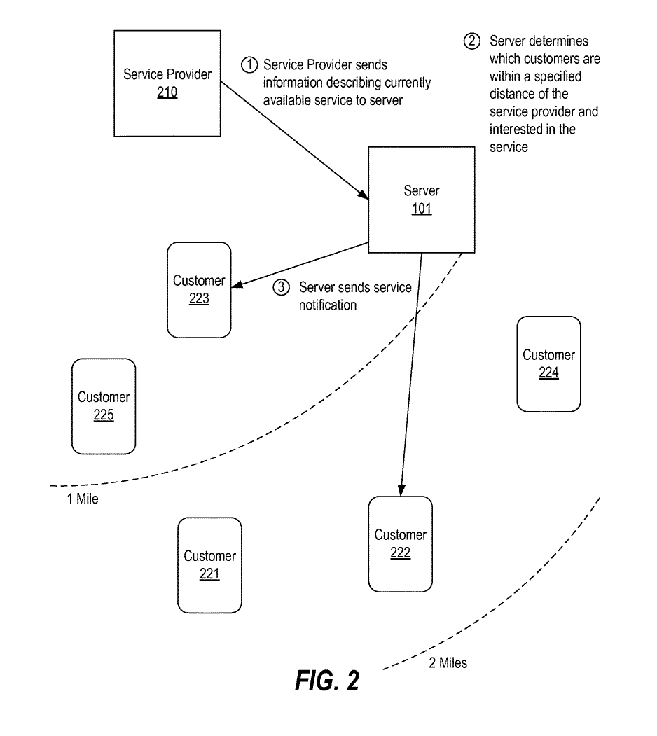

FIG. 2 illustrates an example of how service notifications can be sent to selected customers. FIG. 2 includes a service provider system 210, server system 101, and five customer devices 221-225. Service provider system 210 and customer devices 221-225 represent instances of client systems 102a-102n. Although FIG. 2 depicts server system 101 as being nearby service provider 210, server system 101 can be in any location as long as it is able to communicate with the service provider and customer devices. In this example, it will be assumed that the service provider provides automotive services. It will also be assumed that each of the customers associated with customer devices 221-225 has registered with server system 101 to receive service notifications. The following table summarizes a generalized example of the information that can be maintained by server system 101 to enable the server system to determine which customers should receive a service notification from service provider 210.

| Customer Identifier | Interests | Distance |
|---|---|---|
| 221 | Automotive | 1 mile |
| 222 | Automotive | 2 miles |
| 223 | Automotive | 2 miles |
| | Health and Beauty | 4 miles |
| 224 | Health and Beauty | 3 miles |
| 225 | Automotive but not | 2 miles |
| | service provider 210 | |

As shown, customer 221 has specified an interest in receiving automotive service notifications when he is within 1 mile of the service provider. Customer 222 has specified an interest in receiving automotive service notifications when she is within 2 miles of the service provider. Customer 223 has specified an interest in receiving automotive service notifications and health and beauty service notifications when she is within 2 and 4 miles respectively of the service provider. Customer 224 has specified an interest in receiving health and beauty service notifications when he is within 3 miles of the service provider. Finally, customer 225 has specified an interest in receiving automotive service notifications when he is within 2 miles of the service provider but does not want to receive service notifications from service provider 210.

As represented as step 1 in FIG. 2, service provider 210 sends information describing a currently available automotive service to server system 101. This information can include an identification of the type of service (i.e., Automotive). Alternatively, in some embodiments, server system 101 may store information defining the type of service that service provider 210 provides (e.g., if service provider 210 only provides one type of service). In such cases, the information provided by service provider 210 may not need to specify the type of the currently available service.

The information sent to server system 101 by service provider 210 can also include a description of the currently available service. For example, the information can describe the currently available service as an oil change service that can be immediately received due to the service provider having an empty stall. This information may also include an offer, incentive, or discount that can be received upon having the service performed. For example, the information can include a coupon to receive a reduced price on an oil change if the customer visits the service provider promptly.

Server system 101 can receive this information and generate an appropriate service notification. For example, if server system 101 employs a mobile application platform to communicate service notifications, server system 101 can format the information into the appropriate format for display within a mobile application. In some embodiments, this format can include a rating for service provider 210.

As represented as step 2 in FIG. 2, server system 101 can then determine which customers should receive the service notification. Referring to the table above, server system 101 can identify that customers 221, 222, 223, and 225 have specified an interest in receiving automotive service notifications. However, because customer 225 has blacklisted service provider 210, customer 225 will not be considered as a potential recipient. Customers 221, 222, and 223 are therefore potential recipients of the service notification subject to determining whether they are within the specified distance of service provider 210.

To determine whether each of customers 221, 222, and 223 are within the specified distance, server system 210 can obtain or access current location information for each of the customers. As described above, this current location information, which can be in the form of GPS coordinates, can be obtained (and stored) by server system 101 at regular intervals, or may be retrieved on demand in response to receiving the information from service provider 210. The current location information can be compared to a known location of service provider 210 to determine the distance of each customer from service provider 210. As shown in FIG. 2, customers 221 and 222 are between 1 and 2 miles away from service provider 210 while customer 223 is within 1 mile of service provider 210.

Although this example assumes that service provider 210 is at a fixed location, this process can also be performed when service provider 210 is mobile. In such cases, service provider 210 can provide its current location to server system 101 (e.g., within the information describing the currently available service) for use in determining the distance of each customer from service provider 210.

Server system 101 can then compare the distance of each customer from service provider 210 to the corresponding specified distance. Referring again to the table, customer 221 has specified a distance of 1 mile, but is currently over 1 mile away from service provider 210. Therefore, server system 101 can determine that the service notification should not be sent to customer 221 even though customer 221 has specified an interest in receiving automotive service notifications.

Customer 222 has specified a distance of 2 miles and is within 2 miles of service provider 210. Therefore, as indicated as step 3 in FIG. 2, server system 101 can send the service notification to customer 222. Similarly, customer 223 has specified a distance of 2 miles for automotive service notifications and is within 1 mile of service provider 210. Therefore, server system 101 can also send the service notification to customer 223. Server system 101 therefore sends the service notification only to customers 222 and 223 since they have expressed an interest in automotive service notifications and are within the specified distance.

In some embodiments, rather than using the current location of the customer to determine whether the customer should receive a service notification, server system 101 can use a customer specified location that is not the current location of the customer. For example, a customer that plans to visit a city may provide a location within the city to server system 101. Server system 101 may then use this customer provided location in the same manner as described above regarding the use of the customer's current location. The customer may then receive service notifications from service providers that are within a specified distance of the customer provided location. Using a customer provided location rather than the customer's current location can enable the customer to learn of services that may be available in a location that the customer may visit in the future.

Although the above description suggests that server system 101 makes a single determination of which customers are to receive a service notification (e.g. immediately upon receiving the information from service provider 210), server system 101 may also determine which customers should receive a service notification on an ongoing basis. Making this determination on an ongoing basis can allow a service notification to be sent to customers that may enter within a specified distance of the service provider after server system 101 has already made a determination of which customers are to receive the service notification.

In some embodiments, to facilitate making the determination on an ongoing basis, the information provided by the service provider can include an expiration. The expiration can indicate when the service will no longer be available. Server system 101 can use the expiration to identify a duration of time during which server system 101 should make determinations of which customers should receive a service notification. Referring to the example of FIG. 2, service provider 210 can include an expiration that indicates that automotive service notifications should be sent out for the next four hours (e.g. in the form of a relative time such as four hours or a specific time such as until 5:00 PM). In response, server system 101 can determine which customers are to receive the service notification on an ongoing basis for four hours. These determinations can be made at a set frequency (e.g. every five minutes), on demand (e.g. whenever a customer enters within a pre-determined distance of service provider 210), or in accordance with another schedule.

Using an expiration can be beneficial when a service provider knows that a service will be available for a duration of time. For example, a real estate agent may be hosting an open house for the next three hours, and may therefore request that service notifications be sent to customers within a specified distance of the open house for the next three hours.

In some embodiments, such as when the distance between a customer that may receive a service notification and the service provider is substantial, a service notification can be associated with a last message time that differs from the expiration of the service. For example, a service provider may request that a service notification be sent out and include an expiration of 5:00 PM. However, the service provider may be located in a place that will typically require 30 minutes of travel time to reach the service provider. In such cases, a service notification can include a last message time of 4:30 PM to prevent service notifications from being sent to customers at a time when they would no longer be able to reach the service provider by 5:00 PM.

This last message time can be included in the information sent by the service provider to server system 101 as described above or may be automatically calculated by server system 101. For example, a last message time can be dynamically calculated by server system 101 based on the location of each customer that may potentially receive the service notification. In such cases, even if the customer is within the specified distance of the service provider, but the time required to travel from the customer's current location to the service provider is greater than the difference between the current time and the expiration of the service, server system 101 may choose not to send the service notification. Stated another way, as the expiration of the service approaches, server system 101 can determine to send service notifications only to customers within a decreasing radius from the service provider regardless of each customer's specified distance.

The present invention may also include embodiments where the customer is able to send requests for service to service providers. In such embodiments, the flow of information is in a generally reverse direction from what is described above. In other words, the customer can send information to server system 101, and server system 101 can generate service requests to send to service providers.

A customer may submit information describing a service that the customer would like performed. For example, the customer can send information indicating that the customer would like a plumbing service performed. This information may include a current location of the customer (if not already reported to server system 101). In some embodiments, this information can include a distance that is used to determine which service providers should receive the resulting service request. In other embodiments, this information may not include a distance. The information may also include an indication of one or more types of information the customer would like to receive from service providers. For example, the information may request a quote and an estimated time for performing the service. The information may also identify one or more service providers to which the customer would not like the service request to be sent.

Server system 101 can store information about service providers that can be used to determine which service providers should receive a particular service request. For example, server system 101 may allow a service provider to register to receive service requests by specifying one or more types of requests that the service provider would like to receive. If the service provider has a fixed location, the service provider may provide its location during registration. Alternatively, if the service provider is mobile, it may agree to report its current location at regular intervals or on demand.

The location of a service provider can be used to determine whether the service provider should receive a service request. When a customer submits information describing a particular type of service to be performed, server system 101 can identify the customer's current location and compare it to the location of a number of service providers that provide the particular type of service. The service providers that are within a specified distance of the customer's current location may receive the service request.

The specified distance that is used to determine whether a particular service provider will receive a service request can be calculated in various ways. For example, a service provider may indicate a distance that it is willing to travel to perform a service. If the service provider is within this indicated distance from the customer's current location (whether based on a fixed or mobile location of the service provider), the service provider may be selected to receive the service request. Alternatively, the customer may specify a distance as described above. Such may be the case when the customer will travel to the service provider rather than the service provider travelling to the customer. In such cases, if the service provider's location is within the specified distance of the customer's current location, the service provider may be selected to receive the service request.

In some embodiments, a location other than the customer's current location can be used. For example, a customer that is not present at a location may request that a service be performed at the location such as when a customer on vacation requests a service at his home, or when a customer that is about to travel requests service at the location to which he will travel. In such cases, any service provider receiving a service request may be notified that the location where the service is to be provided is not the current location of the customer. This may encourage the service provider to verify that the service request is legitimate prior to traveling to the location.

Server system 101 can generate a service request using the information provided by the customer. For example, if the customer-provided information includes a request for a quote or estimated time, the generated service request can also include such information. The service request may also provide functionality for a service provider to respond to the customer. For example, the service request may include the customer's contact information so that the service provider may directly contact the customer. Alternatively, the service request may enable the service provider to respond to the customer indirectly through server system 101 (e.g., via the same application used to view the service request). Indirect responses may be preferred in some cases because it allows the customer to review available service providers without having to reveal contact information to potentially many service providers.

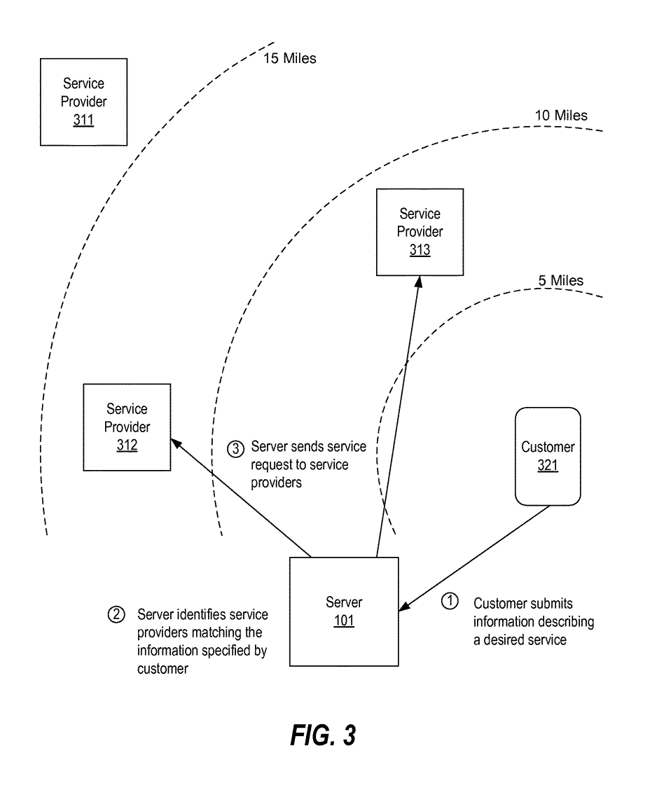

FIG. 3 illustrates an example of how service requests can be sent to selected service providers. FIG. 3 includes a customer device 321, server system 101, and three service provider systems 311-313. Customer device 321 and service provider systems 311-313 represent instances of client systems 102a-102n. In this example, it will be assumed that service providers 311-313 each provide plumbing services and have registered to receive service requests for plumbing services.

Server system 101 can maintain an indication that each of service providers 311-313 would like to receive service requests pertaining to plumbing. In some instances, server system 101 may also store a distance for each of service providers 311-313 representing how far each service provider is willing to travel. Alternatively, server system 101 may employ a default distance for one or more of service providers 311-313.

As shown as step 1 in FIG. 3, customer 321 submits information describing a plumbing service that he would like to have performed. In some embodiments, this information can include a location of customer 321. Alternatively, a previously specified location (which may be a fixed (e.g., home) address in some cases) can be stored by server system 101. In any case, server system 101 can identify a location of customer 321 in response to receiving the information of the customer.

As shown as step 2 in FIG. 3, server system 101 can use the information provided by customer 321 along with information known about a number of service providers to identify potential recipients of a service request. Because customer 321 has indicated a desire to receive a plumbing service, server system 101 can identify service providers 311-313, from among potentially many service providers, as potential recipients of the plumbing service request.

Server system 101 may also use a specified distance to determine which of service providers 311-313 should receive the plumbing service request. In this example, it will be assumed that the service provider will travel to customer 321's location to perform the service. Therefore, server system 101 can employ a distance specified by each of service provider's 311-313 in determining whether any of the service providers should receive the plumbing service request.

In this example, for the sake of simplicity, it will be assumed that each service provider has specified a willingness to travel up to 15 miles to perform a plumbing service. Because service provider 311's location (whether fixed or mobile) is more than 15 miles from customer 321's location (which may be his home location), server system 101 can select not to send the plumbing service request to service provider 311. In contrast, both service providers 312 and 313 are within 15 miles of customer 321's location. Therefore, server system 101 can send the plumbing service request to service providers 312 and 313.

As suggested above, a location of a service provider can be mobile. For example, a plumber may report his current location (e.g., the GPS coordinates of his phone) to server system 101 to be used in determining whether the plumber will receive service requests. The present invention can therefore facilitate locating and contacting a service provider that may be performing a service at a nearby home or location and that could quickly stop by to perform another service. The present invention, however, may also be beneficial when the service provider's location is fixed. For example, a customer could request the transmission of a service request to nearby auto shops to identify if any of them could perform an automotive service immediately.

In some embodiments, server system 101 can include a customer rating in a service request. A customer rating can be helpful for alerting service providers of customers that may be difficult to work for or that may be less likely to pay. A customer rating may also be helpful for alerting service providers of quality customers that may be worth the effort of visiting or accepting. A customer rating can be established over time such as based on reviews submitted by service providers that have performed a service for the customer. In some embodiments, a customer that generates a service request may be given access to service provider ratings to assist the customer in selecting a service provider.

The present invention may also include embodiments where server system 101 tracks or otherwise learns a path that the customer travels. Then, in response to a customer specifying an interest in a service, server system 101 can identify and display service providers that are located along the customer's path.

Server system 101 can identify a path for a customer in various ways. For example, an application executing on a customer device can identify a series of locations while the customer is travelling between two locations such as between home and work. Server system 101 can employ this series of locations as a path for the customer. Alternatively, a customer may manually input a path such as by inputting beginning and end locations. In any case, server system 101 can store the path to allow the server system to identify service providers that provide a particular service that are located along the path.

Once server system 101 has identified a path of the customer, the customer can specify an interest in a particular type of service. In some embodiments, the customer may also specify the path to be used. Alternatively, server system 101 may automatically identify a path to be used based on a current location of the customer (which may be included when the customer specifies the interest in the type of service). For example, a mobile application executing on a customer's device may include an interface for receiving customer input identifying a type of service such as restaurants, sporting goods stores, auto shops, bakeries, gyms, etc.

In response to receiving the customer's specified interest in a type of service, server system 101 can identify a number of service providers that are located along the path and cause these service providers to be displayed to the customer on the customer device. For example, if the customer specifies an interest in fast food restaurants and it is determined that the customer is travelling home from work, server system 101 can display all fast food restaurants that are located along the customer's path home.

In some embodiments, the customer may specify a maximum distance from the path that a service provider can be located. For example, a customer may specify that he wants to know which fast food restaurants are within half a mile of the path home. Each fast food restaurant matching this criteria can then be selected for display to the customer. Alternatively, a default distance can be used.

Accordingly, the present invention allows the customer to identify service providers that are not just simply within a specified distance of the customer's current location or a specified location, but those that are within a specified distance of a path that server system 101 has learned that the customer will travel. The present invention can therefore facilitate identifying a service provider that will be most convenient for the customer to visit while travelling along the path.

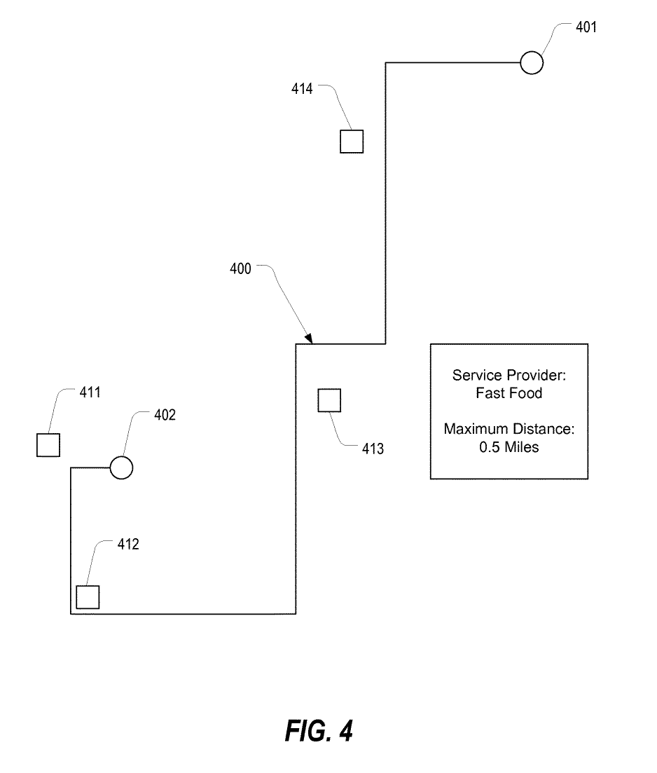

FIG. 4 illustrates an example of how service providers that are located along a customer's path 400 can be displayed. Path 400 extends between a first location 401 and a second location 402 and can represent a path that server system 101 has learned the customer frequently travels.

As shown, the customer has provided input specifying an interest in fast food restaurants that are within 0.5 miles of path 400. The customer may have also provided input selecting path 400, or server system 101 may have automatically identified path 400 such as by determining that the customer is positioned at either location 401 or 402 or is travelling along path 400.

FIG. 4 represents a case where server system 101 has identified four fast food restaurants 411-414 that are located within 0.5 miles of path 400 and has caused these four fast food restaurants to be displayed along path 400 on the customer's device. Although FIG. 4 illustrates that the entire path and all service providers are displayed at the same time, in some embodiments, a portion of the path and each identified service provider that is within the specified distance of the portion may be displayed at a given time. This portion can correspond to the customer's current location and can therefore be updated as the customer travels along the path. In some embodiments, a service provider can be automatically displayed along the path as the customer's current location approaches the location of the service provider. Alternatively, rather than displaying the service providers adjacent the path on the map, a list of service providers can be provided whether within the map or in a separate interface.

Accordingly, the present invention can automatically identify a path that the customer travels and display service providers matching a customer's specified interest that are located along the path.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description.

1. A method, performed by a computing system, for sending service notifications to nearby customers, the method comprising:
receiving, from a service provider, information describing a currently available service that the service provider provides;
accessing customer information to identify one or more customers that have specified an interest in receiving service notifications from the service provider;
determining, from the customer information, a location of each of the one or more customers;
comparing the location of each of the one or more customers to a location of the service provider; and
sending a service notification to each of the one or more customers whose location is within a specified distance of the service provider, the service notification indicating that the service is currently available at the service provider.

2. The method of claim 1, wherein the currently available service is a first type of service, and identifying one or more customers that have specified an interest in receiving service notifications from the service provider comprises determining that the one or more customers have specified an interest in receiving service notifications of the first type of service.

3. The method of claim 1, wherein the current location of each of the one or more customers is received prior to or in response to receiving the information describing the currently available service.

4. The method of claim 1, wherein the location of a customer comprises GPS coordinates of a computing device of the customer.

5. The method of claim 1, wherein the location of a customer comprises a customer provided location that is different from a current location of the customer.

6. The method of claim 1, wherein the specified distance comprises a distance specified by each customer.

7. The method of claim 1, wherein the customer information includes a specified distance for each of the one or more customers.

8. The method of claim 1, wherein the customer information for a first customer includes an indication of multiple types of services for which the first customer would like to receive service notifications.

9. The method of claim 8, wherein each of the multiple types of services is associated with a specified distance.

10. The method of claim 1, wherein the service notification includes a rating of the service provider.

11. The method of claim 1, wherein the currently available service is associated with an expiration, and wherein the acts of determining, comparing, and sending are performed on an ongoing basis up to the expiration.

12. The method of claim 1, wherein the currently available service is associated with an expiration and a last message time, and wherein the acts of determining, comparing, and sending are performed on an ongoing basis up to the last message time, the last message time being before the expiration.

13. A method, performed by a computing system, for sending service requests to nearby service providers, the method comprising:
receiving, from a customer, information describing a service that the customer would like performed;
accessing service provider information to identify one or more service providers that provide the service;
determining, from the service provider information, a location of each of the one or more service providers;
comparing the location of each of the one or more service providers to a location of the customer; and
sending a service request to each of the one or more service providers that has a location that is within a specified distance of the customer, the service request identifying the service that the customer would like performed.

14. The method of claim 13, wherein the location of at least one of the customer or the one or more service providers is a current location reported to the server system on a regular basis.

15. The method of claim 13, wherein the specified distance comprises a distance specified by the service provider.

16. The method of claim 15, wherein the distance specified by the service provider is a distance the service provider is willing to travel to perform the service.

17. The method of claim 13, wherein the specified distance comprises a distance specified by the customer.

18. The method of claim 17, wherein the distance specified by the service provider is a distance the customer is willing to travel to receive the service.

19. The method of claim 13, wherein the information describing the service that the customer would like performed includes a request for a quote to perform the service or an estimated time when the service provider would be able to perform the service, and wherein the service request includes the quote or estimated time.

20. The method of claim 13, wherein the service request includes a rating of the customer.

21. The method of claim 13, wherein the location of the customer is a location other than a current location of the customer.

22. A method, performed by a computing system, for displaying service providers of interest to a customer that are located along a path of the customer, the method comprising:
identifying a path that the customer has or will travel;
receiving, from the customer, an indication that the customer is interested in a particular type of service;
determining one or more service providers that provide the particular type of service and that are located within a specified distance of the path; and
causing the one or more service providers to be displayed to the customer.

23. The method of claim 22, wherein identifying a path that the customer has or will travel comprises determining, based on a series of locations, that the customer has previously traveled along that path.

24. The method of claim 22, wherein the specified distance is received from the customer.

25. The method of claim 22, wherein the one or more service providers are displayed along a displayed version of the path.

26. The method of claim 22, wherein the one or more service providers are displayed in a list.

27. The method of claim 22, wherein a service provider is caused to be displayed when the customer approaches the location of the service provider.
